(19) United States
(12) Patent Application Publication
(10) Pub. No.: US 2006/0053062 A1
(43) Pub. Date: Mar. 9, 2006

(54) Method and system for managing a inauguration investment lottery

(76) Inventor: Sangkoo Park, Seoul (KR)

Correspondence Address: BACON & THOMAS, PLLC, 625 SLATERS LANE, FOURTH FLOOR, ALEXANDRIA, VA, 22314, US

(21) Appl. No.: 10/535,911

(22) PCT Filed: Sep. 20, 2004
(86) PCT No.: PCT/KR04/02410

§ 371 Date: May 23, 2005

(30) Foreign Application Priority Data
Oct. 22, 2003 (KR) 10-2003-0073654

(51) Int. Cl. G06Q 30/00; G06Q 40/00

(52) U.S. Cl. 705/26; 705/35

(57) ABSTRACT

A method and system for managing an on-line inauguration investment lottery, which creates an effective association of a lottery business with inauguration enterprise support. With the method and system, since enterprise founders and inauguration enterprises can attract investments funds, promising businesses can be prevented from being hoarded, and moreover, enterprise inaugurations can be promoted.

### TECHNICAL FIELD

The present invention relates to a method and system for managing an inauguration investment lottery, and more particularly, to a method and system for managing an inauguration investment lottery, which is capable of taking over inauguration enterprise stocks as a part of the prize money.

### BACKGROUND ART

In recent years, various lottery businesses including a public lottery and an Internet lottery have been operated. The Internet lottery has been managed in such a manner that a payment for an Internet lottery ticket is made on the Internet and prize money is paid to a winner of the prize by the lot.

Such conventional lottery businesses mainly employ a system of payment of only prize money and, attendantly, a system that cars or household appliances are provided as premiums or a part of prize money in order to attract consumers who are demanding a system of payment other than only prize money. In any of the systems, the conventional lottery businesses have a strong negative aspect in that they stir up a speculative spirit. Accordingly, there is a problem in that persons who purchase lottery tickets are impressed as persons who rely on chance and their lottery ticket purchase is perceived as a negative influence on society. In the meantime, although the lottery businesses adopt a platform of the public business find raising, there is a problem in that actual measures to support a number of inauguration enterprises desiring investment funds are not made, which results in insignificant effectiveness of the public business fund raising.

On the other hand, although a number of inauguration enterprises including venture enterprises have excellent techniques and promising business items, they actually suffer from difficulties due to a lack of business funds. Inauguration investment companies and associations have been found and managed to support these inauguration enterprises, however, they have a realistic difficulty in investing a great deal of funds due to a risk on the business.

Nevertheless, since the venture enterprises retain a business property of high risk and high return, success in their business gives a lot of profit to investors, and moreover, contributes to the growth of national industry. Accordingly, there is a keen need for attraction of investment from the investors.

### DISCLOSURE

### Technical Problem

Therefore, the present invention has been made in view of the above problems, and it is an object of the present invention to provide a method and system for managing an inauguration investment lottery, which creates an effective association of a lottery business with inauguration enterprise support.

### Technical Solution

In accordance with an aspect of the present invention, the above and other objects can be accomplished by the provision of a method for managing an on-line inauguration investment lottery, comprising the steps of:

(a) by an inauguration enterprise manager of a service provider server, storing information on an inauguration enterprise to issue stocks to be provided to a prize winner of the inauguration investment lottery in an enterprise information database of the service provider server and sending the stored information on the inauguration enterprise to user terminals via a communication network in response to requests from the user terminals; (b) by a lottery issuance manager and a lottery drawing manager of the service provider server, issuing and drawing, respectively, inauguration investment lotteries which can be exchanged with inauguration enterprise stocks amounting to money corresponding to a predetermined inauguration enterprise stock subscription costs of total prize money; (c) receiving personal information and prize information of a decided winner of the prize from a terminal of the decided winner of the prize; (d) by a prize winning lottery manager of the service provider server, generating a stock subscription bill including information required to request the inauguration enterprise stock subscription from the winner of the prize, based on the personal information and prize information received in the step c), and sending the generated stock subscription bill to the terminal of the winner of the prize via the communication network; (e) by the winner of the prize, confirming the stock subscription bill and then sending the confirmed stock subscription bill to the service provider server via the communication network using the terminal of the winner of the prize; and (f) by the prize winning lottery manager of the service provider server, receiving the stock subscription bill sent by the winner of the prize and providing the winner of the prize with the inauguration enterprise stocks as a part of the prize money.

In accordance with another aspect of the present invention, the above and other objects can be accomplished by the provision of a system for managing an on-line inauguration investment lottery, which creates an effective association of a lottery business with inauguration enterprise support using a service provider server and user terminals, which are connected to a communication network, wherein the service provider server comprises an inauguration enterprise manager for storing information on an inauguration enterprise to issue stocks to be provided to a winner of the prize of the inauguration investment lottery in an enterprise information database of the service provider server and sending the stored information on the inauguration enterprise to the user terminals via the communication network in response to requests from the user terminals; a lottery issuance manager and a lottery drawing manager for issuing and drawing, respectively, inauguration investment lotteries which can be exchanged with inauguration enterprise stocks amounting to money corresponding to a predetermined inauguration enterprise stock subscription costs of total prize money, in order to decide a winner of the prize; and a prize winning lottery manager for generating a stock subscription bill including information required to request the inauguration enterprise stock subscription from the winner of the prize, based on inputted personal information and prize information, sending the generated stock subscription bill to a terminal of the winner of the prize via the communication network, and, upon receiving the stock subscription bill sent by the winner of the prize, providing the winner of the prize with the inauguration enterprise stocks as a part of the prize money, and wherein the winner of the prize inputs the personal information and prize information of the winner of the prize to the terminal of the winner of the prize, sends the inputted personal information and prize information via the communication network, confirms the stock subscription bill, and sends the confirmed stock subscription bill to the service provider server via the communication network.

### DESCRIPTION OF DRAWINGS

The above and other objects, features and other advantages of the present invention will be more clearly understood from the following detailed description taken in conjunction with the accompanying drawings, in which:

FIG. 1 is a block diagram illustrating an example of a system for performing a method for managing an on-line inauguration investment lottery according to the present invention;

FIG. 2 is a flow chart illustrating main steps in the method for managing an on-line inauguration investment lottery according to the present invention, which is performed in the system of FIG. 1;

FIG. 3 is a diagram illustrating an example of an inauguration enterprise stock subscription bill to take over inauguration enterprise stocks in the method and system according to the present invention; and

FIG. 4 is a diagram illustrating another example of an inauguration enterprise stock subscription bill to take over inauguration enterprise stocks in the method and system according to the present invention.

### MODE FOR INVENTION

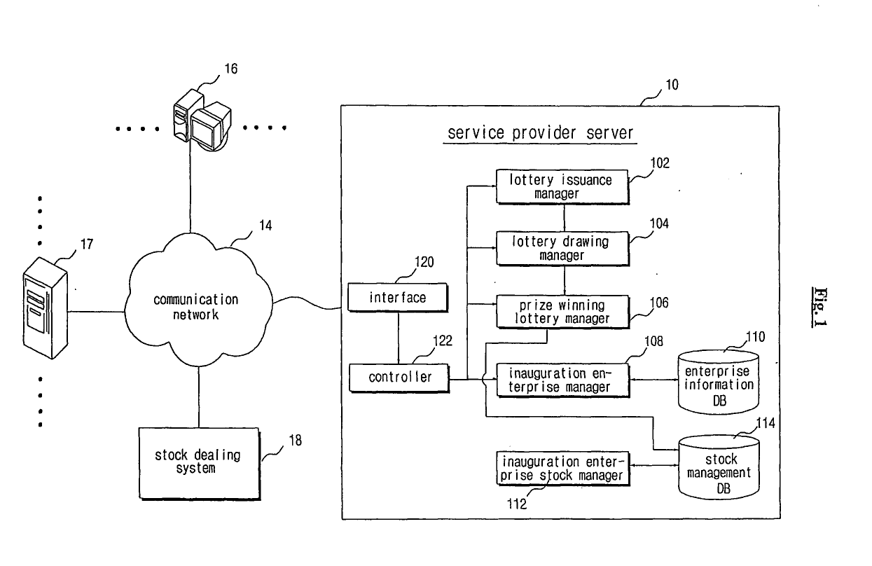

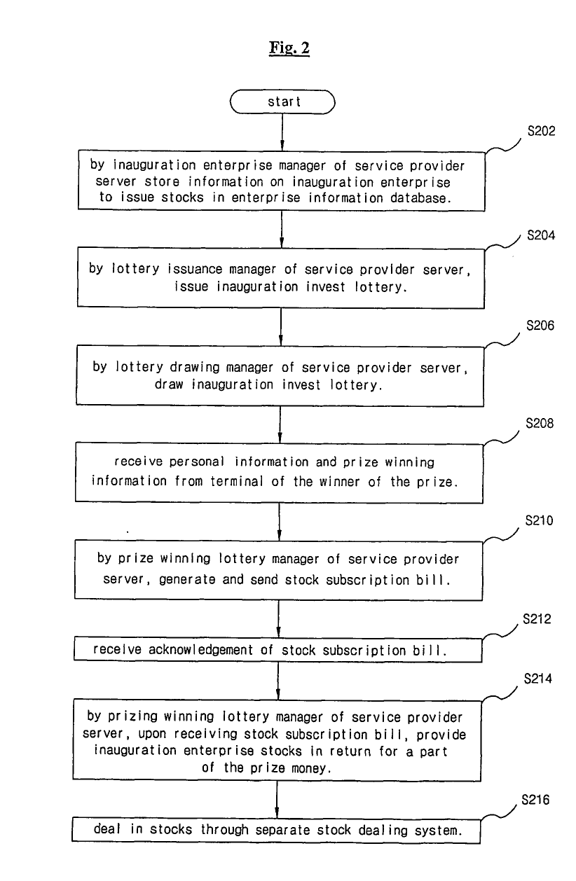

FIG. 1 is a block diagram illustrating an example of a system for performing a method for managing an on-line inauguration investment lottery according to the present invention. FIG. 2 is a flow chart illustrating main steps in the method for managing an on-line inauguration investment lottery according to the present invention, which is performed in the system of FIG. 1.

Referring to FIG. 1, a service provider server 10 is connected to a user terminal 16 via a communication network 14 in order to provide a method and system for managing an inauguration investment lottery, which creates an association of lottery businesses with inauguration enterprise support.

The service provider server 10 includes a lottery issuance manager 102 for managing issuance of the inauguration investment lottery on an off-line or on-line, a lottery drawing manager 104 for managing drawing of the inauguration investment lottery, a prize winning lottery manager 106, an inauguration enterprise manager 108, an enterprise information database 110, an inauguration enterprise stock manager 112 for managing information on stocks to be provided to prize winners of the inauguration investment lottery, and a stock management database 114. In addition, the service provider server 10 includes an interface 120 for connecting the service provider server 10 to the communication network 14, and a controller 122 for controlling operation of the above-mentioned components. A lottery vending machine connected to the communication network 14 can also perform all procedures in the following description.

Hereinafter, operation of the system for managing the on-line inauguration investment lottery according to the present invention, as configured above, will be described in detail. Actual management of the inauguration investment lottery by the method according to the present invention can be progressed in an order of selection of inauguration enterprises promising for investment, issuance and drawing of the inauguration investment lottery, prize money distribution and stock subscription according to a result of the drawing, post-management of inauguration enterprise for investment and registration in stock market, etc. Of these procedures, the procedure of prize money distribution and stock subscription shows a definite difference between the inauguration investment lottery of the present invention and existing lotteries. More specifically, the inauguration investment lottery is limited in its use in that a part of the prize money must be used for the subscription of stocks issued by a selected inauguration enterprise, and more over, public funds, which are profits on the lottery business, are used for subscription of stocks issued by the selected inauguration enterprise as well, and is recovered if the stocks are disposed, which will be described later.

First, the inauguration enterprise manager 108 stores information on the inauguration enterprise to issue stocks to be provided to the prize winner of the inauguration invest lottery in the enterprise information database 110 of the service provider server (Step S202) and provides the stored information on the inauguration enterprise to the user terminal 16 via the communication network in response to an request from the user terminal 16.

On the other hand, prior to the issuance of the inauguration invest lottery, the procedure of selection of inauguration enterprises and the procedure of initial public offering proceed in advance. Namely, an administrator of the inauguration investment lottery management system receives investment requests from inauguration enterprises in order to select promising inauguration enterprises. Application forms for the investment requests are provided from the inauguration investment lottery management system to inauguration enterprises that wish to collect capital. The application forms for the invest requests include all of information required for evaluation on business feasibility and inauguration enterprise values. More specifically, the application forms may include contents of business items, market size and growth prospects of the business, profiles of the board of directors, intellectual properties possessed by the inauguration enterprises, results of research and development of the inauguration enterprises, skilled technical manpower of the inauguration enterprises, business history up to now, business plan for the future, use plan for funds, financial state, assets state, etc.

Next, the business feasibility of the inauguration enterprises from which the investment requests are received to the inauguration investment lottery management system is evaluated. More specifically, it is evaluated in synthetic consideration of probability of success in business of the inauguration enterprises aiming to collect capital, a degree of the attractiveness to the business, technical capability, management capability, economical and social influence on the business, etc., and a result of the evaluation is stored in the enterprise information database 110 through the inauguration enterprise manager 108 in the Step S202. In this case, specialized evaluation personnel for each business can assist to enhance a level of quality of evaluation.

Next, the evaluation on inauguration enterprise value and the conditions of stock issuance are determined. Namely, manpower, assets, material and immaterial values at the present time are evaluated, and then, based on the evaluation, a share of existing stockholders and the conditions of issuance of new stocks are decided. At this time, a net asset value is obtained by subtracting a liabilities estimated value from an asset estimated value of the inauguration enterprise and then a detailed inauguration enterprise estimated value is derived from an addition of the obtained detailed inauguration enterprise value to a business value in consideration of anticipated profit and loss, growth prospects, etc. On the other hand, the conditions on the stock issuance can be easily decided based on the evaluation on inauguration enterprise value. For example, assuming that the net asset value is a billion Won (in Korean currency), the business opportunity value is a 30 hundred million Won, and accordingly the inauguration enterprise estimated value is a total of 40 hundred million Won, if the inauguration enterprise raises a fund of a billion Won through issuance of stocks to new stockholders, then a gross capital is a 50 hundred million Won, a share of the existing stockholders is 80% of the gross capital, and a share of the new stockholders is 20% of the gross capital. If the total number of issued stocks is 100,000, then 80,000 stocks are shared by the existing stockholders and 20,000 stocks are shared by the new stockholders. At this time, the gross capital of 50 hundred million Won is divided into a capital fund and a surplus fund, which are decided based on a par value of the stocks.

Next, the inauguration enterprises make an application for stockholder public offering. More specifically, the inauguration enterprises make an application for stockholder public offering if they are satisfied with the evaluation on inauguration enterprise value for them and wish to offer stocks for public subscription according to the conditions of issuance of stocks. On the other hand, if the inauguration enterprises are not satisfied with the evaluation on inauguration enterprise value although they pass the evaluation on business feasibility, they may not make an application for stockholder public offering.

Next, inauguration enterprises to issue the inauguration investment lottery are selected among the inauguration enterprises making an application for the stockholder public offering. More specifically, inauguration enterprises that make an application for stockholder public offering, with the evaluation on both of business feasibility and inauguration enterprise value satisfied, are selected, and the selected inauguration enterprises raise investment funds by issuing stocks according to the predetermined conditions.

Next, the lottery issuance manager 102 and the lottery drawing manager 104 issues (Step S204) and draws (Step S206) the inauguration invest lottery which can be exchanged with inauguration enterprise stocks amounting to money corresponding to a predetermined inauguration enterprise stock subscription costs of total prize money. Herein, detailed explanation of Step S204 will be omitted since methods used in the existing lottery or others can be also true of Step S204. In other words, lottery issuance and drawing on an on line as well as an off line is possible. In this case, upon issuing the inauguration investment lottery, information on the inauguration enterprises of which stocks is to be taken over by a winner of prize can be provided through a homepage provided by the service provider sever 10. In addition, Step S206 can be conducted each week or each month. Herein, a detailed explanation of a drawing method of the inauguration investment lottery will be omitted since methods used in the existing lottery or others can be also true of the drawing method.

Herein, in distribution of a sales profit of the inauguration investment lottery, some (about 40% of a total sales profit of the lottery) of the prize money is supplied to the winner of the prize as cash, and the other (about 20% of the total sales profit of the lottery) of the prize money is used for the winner of the prize to take over the inauguration enterprise stocks.

The following Table 1 shows examples of distributions of the sales money of the existing lottery and the inauguration investment lottery.

TABLE 1

| | | | Inauguration | |
|---|---|---|---|---|
| | Existing lottery | | investment lottery | |
| Division | Ratio | Content | Ratio | Content |
| Distribution of | 50% | Distributed | 40% | Distributed |
| prize money | | as cash | | as cash |
| of the lottery | | | 20% | Distributed |
| | | | | as stocks |
| Business | 30% | Commission for | 20% | Commission for |
| expenses, such | | lottery sales and | | lottery sales |
| as sales costs | | business | | and business |
| expenses, such | | lottery sales | | management |
| as sales costs | | and business | | lottery sales |
| | | management | | and business |
| | | expenses | | management |
| | | | | expenses |
| Remaining | 20% | Raised as | 20% | Used for taking |
| profit | | public funds | | over inauguration |
| | | | | enterprise stocks, |
| | | | | and restored as the |
| | | | | public funds when |
| | | | | the stocks are disposed |

In addition, the raised public funds amounting to about 20% of the total sales profit of lottery except for the lottery sales costs and the other business expenses that occupy about 20% of the total sales profits of lottery are used to take over the inauguration enterprise stocks. Accordingly, the other of the prize money and the raised public funds can be supplied as funds of the inauguration enterprises. In this case, the inauguration enterprise stocks taken over using the raised public funds can be restored as the public funds by eventually disposing of them.

On the other hand, since uninscribed lottery tickets with no personal information attached are purchased, the service provider cannot know who wins a prize in the inauguration invest lottery. However, since a stock takeover requires a real name account of a certain sort, which is similar to an opening of an account for the prize money, it is required for the service provider to take personal information and prize information of the winner of the prize of the inauguration investment lottery. Accordingly, the winner of the prize inputs his own personal information and the prize winning information to the service provider server 10 (Step S208). The prize winning lottery manager 106 generates an inauguration enterprise stock subscription bill including information required for the winner of the prize to request a subscription of inauguration enterprise stocks, based on the inputted personal information and the prize winning information, and sends the generated stock subscription bill to the user terminal 16 of the winner of the prize via the communication network 14 (Step S210).

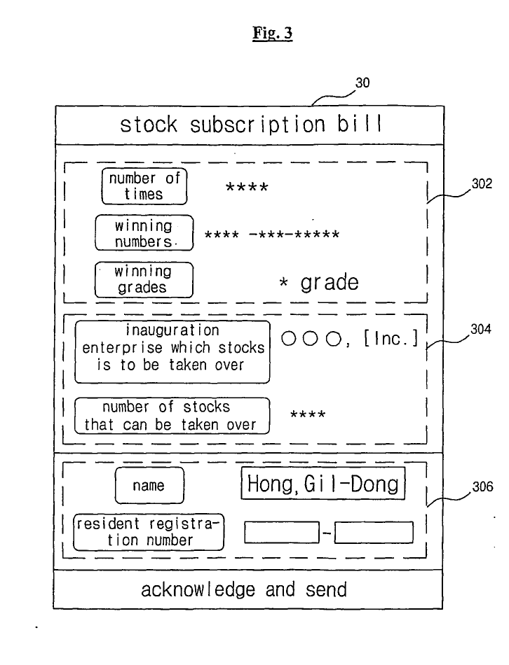

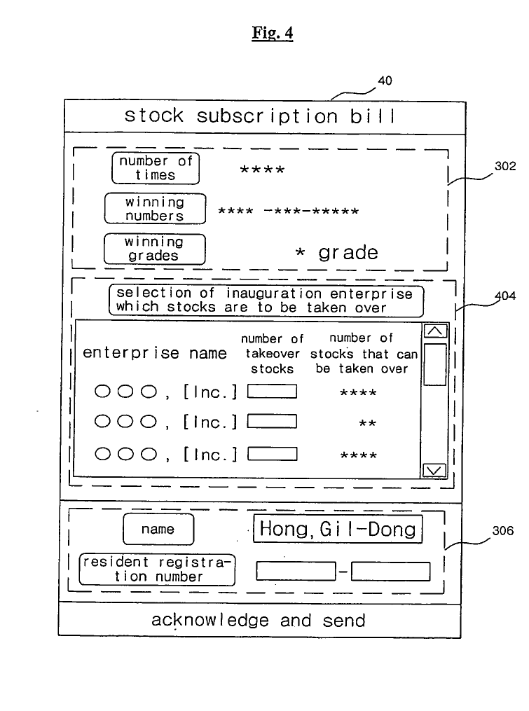

FIG. 3 is a diagram illustrating an example of the inauguration enterprise stock subscription bill to take over inauguration enterprise stocks in the method and system according to the present invention. FIG. 4 is a diagram illustrating another example of an inauguration enterprise stock subscription bill to take over inauguration enterprise stocks in the method and system according to the present invention. Referring to FIG. 3, a stock subscription bill 30 includes a blank 302 in which the prize winning information is filled, a blank 306 in which the personal information is filled, and particularly, a blank 304 in which a name of an inauguration enterprise which stocks are taken over and the number of stocks to be taken over are filled. In this case, the service provider server 10 informs the winner of the prize of the name of the inauguration enterprise and the number of stock to be taken over. Referring to FIG. 4, a stock subscription bill 40 includes a blank 404 provided for a direct selection of inauguration enterprise stocks to be taken over by the winner of the prize, instead of the blank 304 of FIG. 3. Returning to the flow chart of FIG. 3, when the winner of the prize clicks on an acknowledgement button and a send button after filling the number of stocks to be taken over for each inauguration enterprise in the stock subscription bill 40, the service provider server 10 checks the filled stock subscription bill 40, and if it finds that there is any error in the stock subscription bill 40, requests the winner of the prize to correct the error, otherwise, receives an acknowledgement of the stock subscription bill 40 (Step S212).

Next, upon receiving the stock subscription bill, the prize winning lottery manager 106 provides the inauguration enterprise stocks in return for a part of the prize money for the winner of the prize (Step S214).

As described with reference to FIG. 3, the prize winning lottery manger 106 randomly selects the inauguration enterprise stocks of the amount of money corresponding to the stocks to be taken over of the prize money or selects stocks designated at every issuance of lottery by an administrator responsible for the issuance of lottery as the inauguration enterprise stocks. The inauguration enterprise stock manager 112 allots the selected inauguration enterprise stocks to the winner of the prize, settles accounts for the allotted stocks, and stores a result of the settlement in the stock management database 114. At this time, information on the selected inauguration enterprise stocks is inserted in the stock subscription bill.

However, the example of FIG. 3 may not satisfactory to the winner of the prize in that he does not have an opportunity for selecting the inauguration enterprise stocks. Another example of FIG. 4 is provided for the purpose of alleviating such dissatisfaction. As described above with reference to FIG. 4, the blank 404 for selecting the inauguration 106 selects, as stocks to be possessed by the winner of the prize, the inauguration enterprise stocks, which are entered in the blank 404, of the amount of money corresponding to the stocks to be taken over of the prize money from the stock management database 114 of the service provider server 10, and the inauguration enterprise stock manager 112 allots the selected inauguration enterprise stocks to the winner of the prize and settles accounts for the allotted stocks. The stock subscription bill can be prepared on the on-line using the terminal 16 of the winner of the prize, or alternatively, it may be prepared off-line and submitted to the administrator responsible for issuance of the lottery who enters relevant contents in the stock subscription bill on-line to be stored in the stock management database 114.

The method for managing the on-line inauguration investment lottery, as described above, creates an effective association of lottery business with inauguration investment business through the medium of inauguration investment lottery, so that promising venture (inauguration) enterprises can easily raise a great deal of funds for their businesses. In addition, the promising venture enterprises can be post-managed through the method for managing the on-line inauguration investment lottery. Furthermore, this method can grant liquidity to the inauguration enterprise stocks through establishment of a stock dealing system (tentatively named “Venture Securities Dealers' Automated Quotation (VenSDAQ)”), which may lead to a vast inauguration investment system.

At this time, an investor (a purchaser of the inauguration investment lottery), i.e., the winner of the prize, primarily receives cash for a relatively large portion of the prize money, and additionally takes over the venture (inauguration) enterprise stocks. This allows the investor to make an investment (i.e., to purchase the inauguration investment lottery) without hesitation. In addition, the investor (the purchaser of the inauguration investment lottery) gets out of a sense of shame, which may be caused by a speculative spirit when the existing lotteries are purchased, and moreover, can have a plain justification in that the user participates in establishment and growth of venture enterprises, thereby encouraging the purchase of the inauguration investment lottery. Accordingly, the method for managing the on-line inauguration investment lottery according to the present invention will provide a great opportunity for promoting a great according to the present invention will provide a great opportunity for promoting a great number of venture (inauguration) enterprises by supplying the inauguration enterprises with a great deal of inauguration investment funds raised by a conglomeration of small funds of the general public.

On the other hand, the administrator of the service provider server 10 manages the information on the winner of the prize and the information on the stocks taken over by the winner of the prize through the inauguration enterprise stock manager 112 so that the winner of the prize and the inauguration enterprises can be continuously managed. In addition, the administrator of the service provider server 10 continuously supplies winners of the prize with the information on the inauguration enterprises selected through the procedure as described above through the inauguration enterprise manager 108, so that the winners of the prize can confirm the state of management of the inauguration enterprises selected by them.

In addition, the administrator of the service provider server 10 organizes a post-management team with persons having expert knowledge and experience required for support and supervision for the inauguration enterprises so that the invested inauguration enterprises are post-managed. At this time, the inauguration enterprises can be managed by a team dualized into an expert group for each field and a general management group. More specifically, the expert group for each field is responsible for trouble shooting such as a consultation about a particular case, and the general management group chooses a person in charge for each inauguration enterprise who grasps the state of management of an inauguration enterprise under his charge for support and supervision for the inauguration enterprise. In the meantime, the inauguration enterprise manager 108 stores information on the grasped inauguration enterprise in the enterprise information database 110. This information can be open to the winners of the prize through a homepage provided by the service provider server 10.

If there are any inauguration enterprises which stocks are to be taken over by the winners of the prize through the procedures as shown in FIGS. 3 and 4, the winners of the prize who took over the inauguration enterprise stocks can also deal in the stocks through a stock dealing system 18 as shown in FIG. 1 (Step S216 in FIG. 2). More specifically, the winners of the prize or investors can deal in the stocks possessed by the winners of the prize through the stock dealing system 18 operated by the service provider server 10 managing in commission the inauguration enterprise stocks possessed by the winners of the prize or by separate business enterprises. Herein, the stock dealing system 18 (tentatively named “Venture Securities Dealer' Automated Quotation (VenSDAQ)”) refers to a stock dealing market of venture (inauguration) enterprises retaining a business property of high risk and high return, particularly, a stock dealing market for dealing in the stocks of the inauguration enterprises offering stocks for public subscription through the method for managing the inauguration investment lottery according to the present invention. This stock dealing system 18 can be said to be a separate stock dealing market differentialized from a stock exchange dealing in stocks of listed enterprises and a KOSDAQ market dealing in stocks of registered enterprises (in Korea).

In addition, the stock dealing system 18 can be operated such that transactions are established in real time for a constant time, a purchaser and a seller make an application for purchase and sell, respectively, with no limit to transaction time, and, in response to the application, the seller and the purchaser make an application for sell and purchase, respectively, like the stock exchange and the KOSDAQ market.

In this way, by establishing and operating the stock dealing system 18, liquidity can be granted to the stocks possessed by the investors and an additional fund-raising market can be later established. To this end, while managing deposition of the stocks of the investors, the service provider server 10 establishes an electronic dealing system and provides materials on enterprise value evaluation, results and prospects of business for enterprises, recent tendency of enterprises, etc., which can be consulted by persons participating in dealing.

### INDUSTRIAL APPLICABILITY

According to the present invention, since enterprise founders and inauguration enterprises can attract investment funds, promising businesses can be prevented from being hoarded, and moreover, enterprise inaugurations can be promoted.

In addition, according to the present invention, the enterprise founders can escape from unemployment, job hunters can be released from unemployment by being employed in the inauguration enterprises, and the winners of the prize who receive the prize money and become stockholders of the inauguration enterprises can also escape from unemployment. Accordingly, the present invention provides a stepping-stone for accumulation of social richness.

In addition, according to the present invention, since persons who developed promising business items without business funds can be invested with business funds, many persons will be ready to research and develop business items. Accordingly, the present invention accelerates development of science and technology through research and development in various industrial fields.

Furthermore, according to the present invention, a great deal of inauguration investment funds can be raised by a conglomeration of small funds of the general public spent in purchasing the inauguration investment lottery, business finds can be supplied for commercialization of promising business items developed by the general public, and the general public can be employed in inauguration enterprises invested by them. Accordingly, the general public helps one another, thereby leading to popular capitalism.

1. A method for managing an on-line inauguration investment lottery, comprising the steps of:
(a) by an inauguration enterprise manager of a service provider server, storing information on an inauguration enterprise to issue stocks to be provided to a prize winner of the inauguration investment lottery in an enterprise information database of the service provider server and sending the stored information on the inauguration enterprise to user terminals via a communication network in response to requests from the user terminals;
(b) by a lottery issuance manager and a lottery drawing manager of the service provider server, issuing and drawing, respectively, inauguration investment lotteries which can be exchanged with inauguration enterprise stocks amounting to money corresponding to a predetermined inauguration enterprise stock subscription costs of total prize money;
(c) receiving personal information and prize information of a decided winner of the prize from a terminal of the decided winner of the prize;
(d) by a prize winning lottery manager of the service provider server, generating a stock subscription bill including information required to request the inauguration enterprise stock subscription from the winner of the prize, based on the personal information and prize information received in the step c), and sending the generated stock subscription bill to the terminal of the winner of the prize via the communication network;
(e) by the winner of the prize, confirming the stock subscription bill and then sending the confirmed stock subscription bill to the service provider server via the communication network using the terminal of the winner of the prize; and
(f) by the prize winning lottery manager of the service provider server, receiving the stock subscription bill sent by the winner of the prize and providing the winner of the prize with the inauguration enterprise stocks as a part of the prize money.

2. The method as set forth in claim 1, further comprising the steps of:
(g) by the prize winning lottery manger of the service provider server, randomly selecting the inauguration enterprise stocks of the amount of money corresponding to the stocks to be taken over of the prize money or selecting stocks designated at every issuance of lottery by an administrator responsible for the issuance of lottery as the inauguration enterprise stocks; and
(h) by the inauguration enterprise stock manager of the service provider server, allotting the selected inauguration enterprise stocks to the winner of the prize, settling accounts for the allotted stocks, and storing a result of the settlement in a stock management database,
wherein information on the selected inauguration enterprise stocks is inserted in the stock subscription bill.

3. The method as set forth in claim 1, wherein a blank for selecting the inauguration enterprises is provided in the stock subscription bill, and
further comprising the steps of:
(i) selecting, as stocks to be possessed by the winner of the prize, the inauguration enterprise stocks, which are entered in the blank, of the amount of money corresponding to the stocks to be taken over of the prize money from the stock management database of the service provider server; and
(j) by the inauguration enterprise stock manager of the service provider server, allotting the selected inauguration enterprise stocks to the winner of the prize and settling accounts for the allotted stocks.

4. A system for managing an on-line inauguration investment lottery, which creates an effective association of a lottery business with inauguration enterprise support using a service provider server and user terminals, which are connected to a communication network, wherein the service provider server comprises:
an inauguration enterprise manager for storing information on an inauguration enterprise to issue stocks to be provided to a winner of the prize of the inauguration investment lottery in an enterprise information database of the service provider server and sending the stored information on the inauguration enterprise to the user terminals via the communication network in response to requests from the user terminals;
a lottery issuance manager and a lottery drawing manager for issuing and drawing, respectively, inauguration investment lotteries which can be exchanged with inauguration enterprise stocks amounting to money corresponding to a predetermined inauguration enterprise stock subscription costs of total prize money, in order to decide a winner of the prize; and a prize winning lottery manager for generating a stock subscription bill including information required to request the inauguration enterprise stock subscription from the winner of the prize, based on inputted personal information and prize information, sending the generated stock subscription bill to a terminal of the winner of the prize via the communication network, and, upon receiving the stock subscription bill sent by the winner of the prize, providing the winner of the prize with the inauguration enterprise stocks as a part of the prize money, and
wherein the winner of the prize inputs the personal information and prize information of the winner of the prize to the terminal of the winner of the prize, sends the inputted personal information and prize information via the communication network, confirms the stock subscription bill, and sends the confirmed stock subscription bill to the service provider server via the communication network.

5. The system as set forth in claim 4, wherein the prize winning lottery manger randomly selects the inauguration enterprise stocks of the amount of money corresponding to the stocks to be taken over of the prize money or selecting stocks designated at every issuance of lottery by an administrator responsible for the issuance of lottery as the inauguration enterprise stocks, and
the inauguration enterprise stock manager allots the selected inauguration enterprise stocks to the winner of the prize, settles accounts for the allotted stocks, and stores a result of the settlement in a stock management database, and
wherein information on the selected inauguration enterprise stocks is inserted in the stock subscription bill.

6. The system as set forth in claim 4, wherein a blank for selecting the inauguration enterprises is provided in the stock subscription bill, and
wherein the prize winning lottery manger selects, as stocks to be possessed by the winner of the prize, the inauguration enterprise stocks, which are entered in the blank, of the amount of money corresponding to the stocks to be taken over of the prize money from the stock management database of the service provider server, and
the inauguration enterprise stock manager allots the selected inauguration enterprise stocks to the winner of the prize and settles accounts for the allotted stocks.
